(19) United States
(12) Patent Application Publication
(10) Pub. No.: US 2025/0385304 A1
(43) Pub. Date: Dec. 18, 2025

(54) SOLID-STATE BATTERY

(71) Applicant: Murata Manufacturing Co., Ltd., Nagaokakyo-shi (JP)

(72) Inventors: Nobuyuki IWANE, Nagaokakyo-shi (JP); Shunya Hatsugai, Nagaokakyo-shi (JP)

(21) Appl. No.: 19/245,923

(22) Filed: Jun. 23, 2025

Related U.S. Application Data
(63) Continuation of application No. PCT/JP2023/045075, filed on Dec. 15, 2023.

(30) Foreign Application Priority Data
Jan. 13, 2023 (JP) 2023-004054

(51) Int. Cl. H01M 10/0562; H01M 4/02; H01M 4/38; H01M 4/505; H01M 4/525; H01M 10/052

(52) U.S. Cl. CPC H01M 10/0562; H01M 4/382; H01M 4/505; H01M 4/525; H01M 2004/028; H01M 10/052; H01M 2300/0074

(57) ABSTRACT

A solid-state battery including a positive electrode layer containing a positive electrode active material containing lithium and a solid electrolyte, wherein the positive electrode layer has a self-decomposition temperature of 215° C. or higher, and the solid electrolyte contains lithium borosilicate glass.

### CROSS REFERENCE TO RELATED APPLICATIONS

The present application is a continuation of International application No. PCT/JP2023/045075, filed Dec. 15, 2023, which claims priority to Japanese Patent Application No. 2023-004054, filed Jan. 13, 2023, the entire contents of each of which are incorporated herein by reference.

### TECHNICAL FIELD

The present disclosure relates to a solid-state battery.

### BACKGROUND ART

Conventionally, secondary batteries that can be repeatedly charged and discharged have been used for various applications. For example, secondary batteries may be used as power sources of electronic devices such as smart phones and notebook computers.

In a secondary battery, a liquid electrolyte is generally used as a medium for ion transfer that contributes to charge and discharge. More specifically, a so-called electrolytic solution is used for the secondary battery. However, generally, in such a secondary battery, safety is required in terms of preventing leakage of the electrolytic solution. In addition, because an organic solvent and the like for use in the electrolytic solution are flammable substances, safety is required in that respect as well.

Therefore, a solid-state battery using a solid electrolyte instead of the electrolytic solution has been studied.
Patent Document 1: Japanese Patent No. 5211721
Patent Document 2: Japanese Patent Application Laid-Open No. 2021-525449

### SUMMARY OF THE DISCLOSURE

The inventors of the present application have noticed that the conventional solid-state batteries have problems to be overcome, and has newly found a need to take measures therefor. Specifically, the inventors of the present application have found that there is the following problem.

As the positive electrode material in the solid-state battery, a lithium transition metal oxide or a lithium composite transition metal oxide having a crystal structure can be used (see Patent Documents 1 and 2). In this regard, the solid-state battery may be used under a high temperature condition, but under such a high temperature condition, the crystal structure of the positive electrode active material becomes unstable as lithium is desorbed, and due to this, the battery characteristics of the solid-state battery under a high temperature condition may be deteriorated.

The present disclosure has been made in view of such problems. That is, a main object of the present disclosure is to provide a solid-state battery capable of having more suitable battery characteristics even under a high temperature condition.

To achieve the above object, an embodiment of the present disclosure relates to a solid-state battery including: a positive electrode layer containing a positive electrode active material containing lithium and a solid electrolyte, wherein the positive electrode layer has a self-decomposition temperature of 215° C. or higher, and the solid electrolyte contains lithium borosilicate glass.

The solid-state battery according to an embodiment of the present disclosure can have more suitable battery characteristics even under a high temperature condition.

### BRIEF EXPLANATION OF THE DRAWINGS

FIG. 1 is an external perspective view schematically showing a solid-state battery according to an embodiment of the present disclosure.

FIG. 2 is a schematic sectional view of the solid-state battery in FIG. 1 taken along line A-A as viewed in an arrow direction.

FIG. 3 is a graph showing a relative value of relative value of a spacing with respect to a heating temperature of a positive electrode active material in the solid-state battery according to an embodiment of the present disclosure.

### DESCRIPTION OF THE PREFERRED EMBODIMENTS

Hereinafter, the solid-state battery of the present disclosure will be described in detail. Although the description will be made with reference to the drawings as necessary, the illustrated contents are only schematically and exemplarily illustrated for the understanding of the present disclosure, and the appearance, the dimensional ratio, or the like may be different from the actual ones.

The “sectional view” as used in the present description is based on a form (briefly, a form in the case of being cut along a plane parallel to the layer thickness direction) viewed from a direction substantially perpendicular to the stacking direction in the stacked structure of the solid-state battery. In addition, the “plan view” or “plan view shape” used in the present description is based on a sketch drawing when an object is viewed from an upper side or a lower side along the layer thickness direction (that is, the stacking direction mentioned above).

The “vertical direction” and “horizontal direction” used directly or indirectly in the present description correspond to a vertical direction and a horizontal direction in the drawings, respectively. Unless otherwise specified, the same reference signs or symbols shall denote the same members or sites or the same meanings. In a preferred aspect, it can be understood that the downward direction in the vertical direction (that is, the direction in which gravity acts) corresponds to a “downward direction”, and the opposite direction corresponds to an “upward direction”.

The “solid-state battery” as used in the present disclosure refers to, in a broad sense, a battery with the constituent elements being solid and refers to, in a narrow sense, an all-solid-state battery with the constituent elements (particularly preferably all constituent elements) being solid. In a preferred aspect, the solid-state battery in the present disclosure is a stacked solid-state battery configured such that layers constituting a battery constituent unit are stacked with each other, and preferably such layers are formed of a fired body. The “solid-state battery” is a so-called “secondary battery” that can be repeatedly charged and discharged. The “secondary battery” is not excessively restricted by its name, which can encompass, for example, a power storage device and the like.

The feature of the present disclosure relates to a positive electrode layer included in the solid-state battery. Hereinafter, in order to grasp the overall structure of the solid-state battery, the basic configuration of the solid-state battery according to the present disclosure will be first described. However, the configuration of the solid-state battery described here is merely an example for understanding the disclosure, and not considered limiting the disclosure.

### [Basic Configuration of Solid-State Battery]

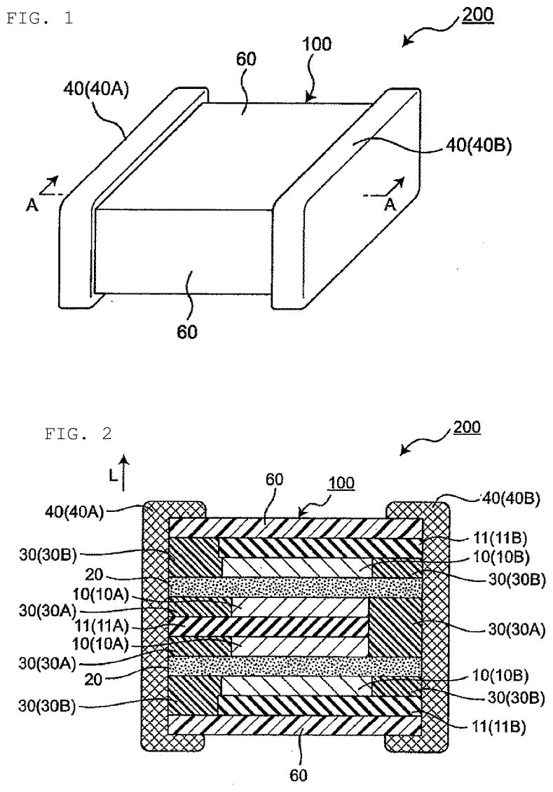

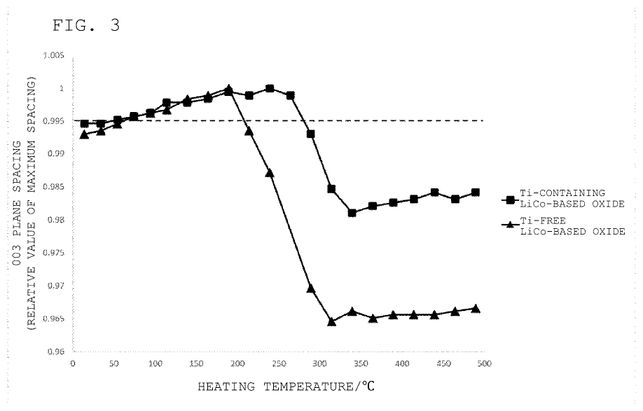

FIG. 1 is an external perspective view schematically showing a solid-state battery according to an embodiment of the present disclosure. FIG. 2 is a schematic sectional view of the solid-state battery in FIG. 1 taken along line A-A as viewed in an arrow direction. The solid-state battery includes at least electrode layers: a positive electrode and a negative electrode, and a solid electrolyte. Specifically, as illustrated in FIGS. 1 and 2, a solid-state battery 200 includes a solid-state battery laminate 100 including a battery constituent unit composed of a positive electrode layer 10A, a negative electrode layer 10B, and a solid electrolyte layer 20 at least interposed between the electrode layers.

The solid-state battery 200 according to the present disclosure usually includes: a solid-state battery laminate 100 including at least one battery constituent unit, including the positive electrode layer 10A, the negative electrode layer 10B, and the solid electrolyte layer 20 interposed therebetween, along a stacking direction L; and a positive electrode terminal 40A and a negative electrode terminal 40B each provided on facing side surfaces of the solid-state battery laminate 100. In the solid-state battery laminate 100, the positive electrode layer 10A and the negative electrode layer 10B are alternately stacked with the solid electrolyte layer 20 interposed therebetween.

For the solid-state battery, each layer constituting the solid-state battery may be formed by firing, and the positive electrode layer, the negative electrode layer, the solid electrolyte layer, and the like may form fired layers. Preferably, the positive electrode layer, the negative electrode layer, and the solid electrolyte layer are each fired integrally with each other, and thus, the solid-state battery laminate preferably forms an integrally fired body.

The positive electrode layer is an electrode layer including at least a positive electrode active material. The positive electrode layer may further contain a solid electrolyte. In a preferred aspect, the positive electrode layer is formed of a fired body including at least positive electrode active material particles and solid electrolyte particles. In contrast, the negative electrode layer is an electrode layer containing at least a negative electrode active material. The negative electrode layer may further contain a solid electrolyte. In a preferred aspect, the negative electrode layer is formed of a sintered body including at least negative electrode active material particles and solid electrolyte particles. The positive electrode layer and the negative electrode layer each having such a configuration can also be referred to as a “composite positive electrode body” and a “composite negative electrode body”, respectively.

The positive electrode active material and the negative electrode active material are substances involved in the transfer of electrons in the solid-state battery. Ions move (conduct) between the positive electrode layer and the negative electrode layer through the solid electrolyte to transfer electrons, thereby charging and discharging the battery. Each electrode layer of the positive electrode layer and the negative electrode layer is preferably a layer capable of occluding and releasing lithium ions or sodium ions, in particular. More particularly, the solid-state battery is preferably an all-solid-state secondary battery in which lithium ions or sodium ions move between the positive electrode layer and the negative electrode layer through the solid electrolyte, thereby charging and discharging the battery.

### (Positive Electrode Layer)

The content of the solid electrolyte in the positive electrode layer 10A is not particularly limited, and is usually 10 to 50 mass %, and particularly preferably 20 to 40 mass % with respect to the total amount of the positive electrode layer. The positive electrode layer may contain two or more types of solid electrolytes, and in that case, the total content thereof may be within the above range.

### (Negative Electrode Layer)

Examples of the negative electrode active material included in the negative electrode layer include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li—Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, but may be each independently, for example, 2 μm to 50 μm, particularly 5 μm to 30 μm.

### (Positive Electrode Current Collector Layer/Negative Electrode Current Collector Layer)

Although not an essential element for the electrode layer, the positive electrode layer and the negative electrode layer may respectively include a positive electrode current collector layer and a negative electrode current collector layer. The positive electrode current collector layer and the negative electrode current collector layer may each have the form of a foil. The positive electrode current collector layer and the negative electrode current collector layer may each have, however, the form of a fired body, if more importance is placed on viewpoints such as improving the electron conductivity, reducing the manufacturing cost of the solid-state battery, and/or reducing the internal resistance of the solid-state battery by integral firing.

As the positive electrode current collector constituting the positive electrode current collector layer and the negative electrode current collector constituting the negative electrode current collector layer, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to a terminal.

It is to be noted that when the positive electrode current collector layer and the negative electrode current collector layer have the form of a fired body, the layers may be composed of a fired body including a conductive material and a sintering aid. The conductive materials included in the positive electrode current collector layer and the negative electrode current collector layer may be selected from, for example, the same materials as the conductive materials that can be included in the positive electrode layer and the negative electrode layer. The sintering aid included in the positive electrode current collector layer and the negative electrode current collector layer may be selected from, for example, the same materials as sintering aids that can be included in the positive electrode layer/the negative electrode layer.

As described above, in the solid-state battery, the positive electrode current collector layer and the negative electrode current collector layer are not essential, and a solid-state battery provided without such a positive electrode current collector layer or a negative electrode current collector layer is also conceivable.

### (Solid Electrolyte)

The solid electrolyte is a material capable of conducting lithium ions or sodium ions. In particular, the solid electrolyte layer that forms the battery constituent unit in the solid-state battery may form a layer capable of conducting lithium ions between the positive electrode layer and the negative electrode layer.

The solid electrolyte layer may contain a sintering aid. The sintering aid contained in the solid electrolyte layer may be selected from, for example, the same materials as the sintering aids that can be contained in the positive electrode layer/negative electrode layer.

The thickness of the solid electrolyte layer is not particularly limited. The thickness of the solid electrolyte layer located between the positive electrode layer and the negative electrode layer may be, for example, 1 μm to 15 μm, particularly 1 μm to 5 μm.

### (Electrode Separator)

The solid-state battery 200 of the present disclosure may further include an electrode separator (also referred to as “margin layer” or “margin portion”) 30 (30A, 30B).

The electrode separator 30A (positive electrode separator) is disposed around the positive electrode layer 10A, so that the positive electrode layer 10A is spaced apart from the negative electrode terminal 40B. The electrode separator 30B (negative electrode separator) is disposed around the negative electrode layer 10B, so that the negative electrode layer 10B is spaced apart from the positive electrode terminal 40A. Although not particularly limited, the electrode separator 30 may be compose of, for example, one or more materials selected from the group consisting of a solid electrolyte, an insulating material, a mixture thereof, and the like.

As the solid electrolyte that can constitute the electrode separator 30, the same material as the solid electrolyte that can constitute the solid electrolyte layer can be used.

The insulating material that can constitute the electrode separator 30 may be a material that does not conduct electricity, that is, a non-conductive material. Although not particularly limited, the insulating material may be, for example, a glass material, a ceramic material, or the like. For example, a glass material may be selected as the insulating material. Although not particularly limited, examples of the glass material include at least one selected from the group consisting of soda lime glass, potash glass, borate glass, borosilicate glass, barium borosilicate-based glass, zinc borate glass, barium borate glass, borosilicate bismuth salt-based glass, bismuth zinc borate glass, bismuth silicate glass, phosphate glass, aluminophosphate glass, and zinc phosphate glass. The ceramic material is not particularly limited, but examples thereof include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

### (Terminal)

The solid-state battery 200 of the present disclosure is generally provided with a terminal (external terminal) 40 (40A, 40B). In particular, terminals 40A and 40B of the positive and negative electrodes are provided to form a pair on a side surface of the solid-state battery. More specifically, the terminal 40A on the positive electrode side connected to the positive electrode layer 10A and the terminal 40B on the negative electrode side connected to the negative electrode layer 10B are provided so as to form a pair. The terminals 40A and 40B may be provided so as to cover at least one side surface of the solid-state battery, and may be referred to as “end face electrodes”. As the terminal 40 (40A, 40B) as described above, it is possible to use a material having high conductivity. Although not particularly limited, examples of the material of the terminal 40 include at least one conductive material selected from the group consisting of silver, gold, platinum, aluminum, copper, tin, and nickel.

The terminal 40 (40A, 40B) may further contain a sintering aid. Examples of the sintering aid include a material similar to the sintering aid that may be contained in the positive electrode layer 10A.

In a preferred embodiment, the terminal 40 (40A, 40B) is composed of a sintered body including at least the conductive material and the sintering aid.

### (Outer Layer Material)

The solid-state battery 200 of the present disclosure usually further includes an outer layer material 60. The outer layer material 60 can be generally formed on an outermost side of the solid-state battery, and used to electrically, physically, and/or chemically protect the solid-state battery. As a material forming the outer layer material 60, preferred is a material that is excellent in insulation property, durability and/or moisture resistance, and is environmentally safe. For example, it is possible to use glass, ceramics, a thermosetting resin, a photocurable resin, a mixture thereof, and the like.

As glass that can constitute the outer layer material, the same material as the glass material that can constitute the electrode separator can be used. In addition, as a ceramic material that can constitute the outer layer material, the same material as the ceramic material that can constitute the electrode separator can be used.

### [Features of Solid-State Battery of Present Disclosure]

The inventors of the present application have intensively studied a solution for providing a solid-state battery having more suitable battery characteristics even under a high temperature condition. More specifically, the inventors of the present application have focused on the positive electrode layer constituting the solid-state battery, and considered that the positive electrode active material and the solid electrolyte contained in the positive electrode layer contribute to suppression of deterioration of battery characteristics of the solid-state battery under a high temperature condition. In this regard, the inventors of the present application have further studied and newly found that the self-decomposition temperature at which the spacing of the positive electrode active material starts to decrease relatively with heating has a correlation with the battery characteristics of the solid-state battery under a high temperature condition (that is, high-temperature resistance of the solid-state battery).

FIG. 3 is a graph showing a relative change in spacing of a lattice plane (003) of a positive electrode active material depending on a heating temperature in a positive electrode layer of the solid-state battery according to an embodiment of the present disclosure. As shown in the drawing, when the positive electrode layer is heated, the spacing gradually increases with an increase in temperature, and eventually reaches a limit point (maximum value). When the heating is further performed, the spacing starts to decrease. Such reduction of the spacing is based on self-decomposition (phase separation) of the positive electrode active material accompanying heating. Therefore, a temperature at which the relative change with respect to the maximum spacing is less than a predetermined amount can also be referred to as “self-decomposition temperature” or “phase separation temperature”. That is, in the specification of the present application, the self-decomposition temperature is a temperature when the spacing of the positive electrode active material turns from the maximum value starts to decrease with the temperature increase and reaches a predetermined ratio (for example, when the relative change is less than 0.995 with the maximum spacing as 1).

The inventors of the present application have newly found that this self-decomposition temperature can be correlated with battery characteristics of the solid-state battery under a high temperature condition. Specifically, the inventors of the present application have found that a positive electrode layer having a self-decomposition temperature of a predetermined temperature or higher under the condition that a solid electrolyte having a specific material composition is contained can be relatively stable under a high temperature condition, and further, a solid-state battery including such a positive electrode layer can be more suitably used even under a high temperature condition, and have devised the disclosure described in detail below.

The solid-state battery of the present disclosure includes a positive electrode layer in which a temperature (so-called “self-decomposition temperature”) at which a relative change with respect to a maximum spacing is less than 0.995 with a value of the maximum spacing measured by XRD analysis while heating the positive electrode layer as 1 in a state where a lithium desorption amount of the positive electrode active material is 40% is 215° C. or higher under the condition that lithium borosilicate glass is contained as a solid electrolyte. In other words, the solid-state battery of the present disclosure includes a positive electrode layer in which, when spacing is measured by X-ray powder diffraction (XRD) analysis performed while heating the positive electrode layer in a state where a lithium desorption amount of the positive electrode active material is 40%, a temperature at which a reduction rate of the spacing is less than 0.5% based on a maximum value thereof is 215° C. or higher.

According to the present disclosure, a solid-state battery having more suitable battery characteristics even under a high temperature condition can be provided by selecting the positive electrode layer having the above-described characteristics. That is, according to the present disclosure, a solid-state battery that is more excellent in high-temperature resistance and that can be more suitably used even under a high temperature condition can be provided. More specifically, in the solid-state battery including the positive electrode layer having the characteristics as described above, even when the solid-state battery is exposed to a high temperature (for example, a temperature range of 80° C. to 200° C.), deterioration of battery characteristics such as a resistance value and/or a battery capacity can be more suitably suppressed. Therefore, the solid-state battery of the present disclosure can more suitably maintain the battery characteristics of the solid-state battery even under a high temperature condition.

The “state where a lithium desorption amount of the positive electrode active material is 40%” refers to a state where the lithium desorption amount is 40% when the desorption amount of lithium with respect to the lithium content of the positive electrode active material is represented as a 100%. In other words, the “state where a lithium desorption amount of the positive electrode active material is 40%” means a state where the lithium content of the positive electrode active material is 60% with the lithium content of the positive electrode active material in a battery in an uncharged state as 100%. For example, the “state where a lithium desorption amount of the positive electrode active material is 40%” may be a charged state where 40% of lithium is extracted from the lithium content of the positive electrode active material in the battery at the time of full discharge.

In the present disclosure, the self-decomposition temperature of the positive electrode active material in a state where 40% of lithium of the positive electrode active material is desorbed is evaluated. This is for more suitably evaluating the behavior of the positive electrode active material under a high temperature condition in a state where the crystal structure of the positive electrode active material may become unstable. Specifically, since lithium is extracted from the positive electrode active material by charging, the crystal structure of the positive electrode active material may become unstable. The destabilization of the crystal structure of the positive electrode active material can be more remarkable under a high temperature condition. That is, under a high temperature condition, the solid-state battery may be easily deteriorated in a state where the lithium desorption amount of the positive electrode active material is about 40% or more. Therefore, by evaluating the self-decomposition temperature in the positive electrode layer in a state where a lithium desorption amount of the positive electrode active material is 40%, it is possible to more suitably correlate the self-decomposition temperature of the positive electrode layer with the high-temperature resistance of the solid-state battery.

Note that the lithium desorption amount can be quantified by XRD analysis of the positive electrode layer of the solid-state battery in a charged state. Alternatively, based on the initial charge/discharge efficiency and the basis weight of the positive electrode active material and the negative electrode active material, the lithium desorption amount can also be calculated from the charge amount of the solid-state battery.

Conventionally, in order to improve high-temperature resistance of a lithium secondary battery using a high nickel-based positive electrode active material, attention has been paid to a phase transition temperature of the positive electrode active material in a fully charged state. Specifically, a high nickel-based positive electrode active material is selected based on a phase transition temperature at which the positive electrode active material changes from a layered structure to a spinel structure in a fully charged state and a temperature at which a maximum value of the c-axis length appears when the temperature of the positive electrode active material increases (see Patent Document 2).

On the other hand, in the present disclosure, as described above, attention is paid to the self-decomposition temperature based on the relative change in spacing of the positive electrode active material with the temperature increase. As shown in FIG. 3, when the temperature of the positive electrode active material continues to increase after reaching the maximum spacing with the temperature increase, the positive electrode active material can maintain a substantially constant spacing and exhibit a behavior in which the spacing starts to decrease by further temperature increase. According to the present disclosure, since the positive electrode active material is evaluated based on the self-decomposition temperature at which the reduction of the spacing starts, it is possible to more suitably select the positive electrode active material capable of suitably maintaining the crystal structure (that is, the temperature until the reduction of the spacing is started is higher) under a high temperature condition (for example, a temperature range of 80° C. to 200° C.).

The upper limit value of the self-decomposition temperature of the positive electrode active material is not particularly limited, but when battery characteristics such as a capacity retention rate at an initial stage (that is, before exposure under a high temperature condition) as a solid-state battery are considered important, the self-decomposition temperature can be, for example, 400° C. or lower, 350° C. or lower, or 330° C. or lower. When emphasis is placed on achieving both suppression of deterioration of battery characteristics in a high-temperature environment and initial battery characteristics of a solid-state battery, the self-decomposition temperature of the positive electrode active material can be 215° C. or higher and 350° C. or lower, 215° C. or higher and 315° C. or lower, 250° C. or higher and 315° C. or lower, or 280° C. or higher and 315° C. or lower.

The lithium borosilicate glass contained in the positive electrode layer is an oxide-based glass material containing at least lithium (Li), silicon (Si), and boron (B) as constituent elements, and can be, for example, 50Li₄SiO₄-50Li₃BO₃. Since such a solid electrolyte has relatively high thermal stability, it is possible to more suitably suppress deterioration of battery characteristics of the solid-state battery under a high temperature condition by containing the solid electrolyte in the positive electrode layer.

In addition to lithium, silicon, boron, and oxygen, one or more additional elements may be added to lithium borosilicate-based glass. For example, the lithium borosilicate-based glass may further contain at least one element selected from elements of Groups 1 and 2 and elements of Groups 14 to 17 of the Periodic Table of the Elements. The respective contents of elements contained in the lithium borosilicate-based glass can be measured by analyzing the glass ceramic-based solid electrolyte using, for example, inductively coupled plasma emission spectroscopy (ICP-AES).

Further, the solid electrolyte may further contain a solid electrolyte used for other known solid-state batteries in addition to the lithium borosilicate-based glass. Such a solid electrolyte may be, for example, any one type, or two or more types of a crystalline solid electrolyte, a glass-based solid electrolyte different from the lithium borosilicate glass, a glass ceramic-based solid electrolyte, and the like. Examples of the crystalline solid electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors.

Examples of the lithium-containing phosphate compounds that have a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. An example of the oxides that have a perovskite structure includes La_{0.55}Li_{0.35}TiO₃. An example of the oxides that have a garnet-type or garnet-type similar structure include Li—La₃Zr₂O₁₂. In addition, examples of the sulfide-based crystal materials include thio-LISICON, for example, Li_{3.25}Ge_{0.25}P_{0.75}S₄ and Li₁₀GeP₂S₁₂. The crystalline solid electrolyte may include a polymer material (for example, a polyethylene oxide (PEO)).

Examples of the glass-based solid electrolyte include oxide-based glass materials and sulfide-based glass materials. Examples of the glass-based solid electrolyte excluding lithium borosilicate glass include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials and sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In addition, examples of the sulfide-based glass ceramic materials include Li—P₃S₁₁ and Li_{3.25}P_{0.95}S₄.

For example, the solid electrolyte may further contain an oxide having a garnet-type or garnet-type similar structure in addition to the lithium borosilicate glass. For example, the positive electrode layer of the solid-state battery of the present disclosure may contain, as a solid electrolyte, lithium borosilicate glass and an oxide containing Li, La, and Zr (also referred to as LLZ or LiLaZr-based oxide). The inventors of the present application have found that when the positive electrode layer contains at least lithium borosilicate glass as a solid electrolyte, the positive electrode active material can preferentially form an interface with lithium borosilicate glass having relatively high thermal stability. Therefore, even when the positive electrode layer contains a solid electrolyte having relatively low thermal stability, the lithium borosilicate glass can suppress the reaction between the positive electrode active material and the solid electrolyte having low thermal stability under a high temperature condition. This makes it possible to further contain another solid electrolyte having excellent lithium ion conductivity although being inferior in thermal stability to lithium borosilicate glass, and it is possible to obtain a solid-state battery more suitably achieving both high-temperature resistance and battery performance (for example, a capacity retention rate or the like).

The content of the lithium borosilicate glass in the solid electrolyte of the positive electrode layer is not particularly limited, and can be, for example, 10 mass % to 90 mass %, 30 mass % to 80 mass %, or 40 mass % to 60 mass % with respect to the total amount of the solid electrolyte in the positive electrode layer. The content of the garnet-type oxide-based solid electrolyte in the solid electrolyte of the positive electrode layer is not particularly limited, but can be, for example, 0 mass % to 70 mass %, 5 mass % to 60 mass, or 10 mass % to 40 mass % with respect to the total amount of the solid electrolyte in the positive electrode layer. When the contents of the lithium borosilicate glass and the garnet-type oxide-based solid electrolyte are each within the above ranges, a solid-state battery that can be more suitably used even under a high temperature condition can be provided.

A constituent material of the positive electrode active material may be a layered rock salt-type metal oxide, specifically, a lithium transition metal oxide. The fact that the positive electrode active material is the layered rock salt-type metal oxide means that the metal oxide (particularly, particles thereof) has a layered rock salt-type crystal structure, and in a broad sense, it means that the metal oxide has a crystal structure that can be recognized as the layered rock salt-type crystal structure by a person skilled in the art of batteries. In a narrow sense, the fact that the positive electrode active material is the layered rock salt-type metal oxide means that the metal oxide (particularly, particles thereof) is identified to have the layered rock salt-type crystal structure by analyzing an X-ray diffraction pattern by Rietveld analysis and the like.

In one embodiment, the positive electrode active material contains an oxide containing Li and Co (also referred to as LCO or LiCo-based oxide), and the LiCo-based oxide contains at least Ti. When the LiCo-based oxide contains at least Ti, the self-decomposition temperature of the positive electrode active material can be increased. That is, the structural stability of the positive electrode active material under a high temperature condition is improved, and a solid-state battery having more excellent high-temperature resistance can be provided.

For example, the self-decomposition temperature of the positive electrode active material containing a Ti-containing LiCo-based oxide can be 215° C. or higher and 350° C. or lower, 250° C. or higher and 330° C. or lower, or 280° C. or higher and lower than 295° C. When the self-decomposition temperature is within the above range, the solid-state battery containing the positive electrode active material in the positive electrode layer can be suitably used even under a high temperature condition.

The Ti-containing LiCo-based oxide may further contain at least one element selected from the group consisting of Al, Mg, Ni, Mn, Zr, Zn, Cu, B, P, Si, Ge, Nb, Au, and Pt. That is, the positive electrode active material may contain a metal composite oxide represented by the composition formula: LiCoₓTi_{y}α_{z}O₂ (I) (wherein x+y+z≤1, 0.9≤x<1, 0.005≤y≤0.01, 0≤z≤0.05, α: at least one element selected from the group consisting of Mg, Al, Ni, Mn, Zr, Zn, Cu, B, P, Si, Ge, Nb, Au, and Pt).

In Formula (I), 0.91≤x<1 is preferable, 0.93≤x≤1 is more preferable, and 0.945≤x≤0.995 is still more preferable. In Composition Formula (I), 0.003≤y≤0.015 may be satisfied, 0.005≤y≤0.01 is more preferable. In Composition Formula (I), 0≤z≤0.08 may be satisfied, 0.005≤z≤0.07, or 0.01≤z≤0.05 may be satisfied. When emphasis is placed on suppressing an increase in resistance value and capacity deterioration under a high temperature condition, a is more preferably Al and/or Mg.

In another embodiment, the positive electrode active material contains an oxide containing Li, Ni, Co, and Mn (also referred to as NCM or LiNiCoMn-based oxide). The positive electrode active material may contain a metal composite oxide represented by the composition formula: LiNiₐCO_{b}Mn_{c}O₂ (II) (wherein a+b+c≤1, 0.3≤a≤0.8, more preferably 0.3≤a≤0.6, 0.2≤b≤0.3, 0.2≤c≤0.3).

The LiNiCoMn-based oxide may further contain Ti, Al and/or Mg. That is, the positive electrode active material may contain a metal composite oxide represented by the composition formula: LiNiₐCo_{b}Mn_{c}β_{d}O₂ (II′) (wherein a+b+c≤1, 0.3≤a≤0.6, 0.1≤b≤0.3, 0.1≤c≤0.3, 0≤d≤0.05, β: at least one element selected from Ti, Mg, and Al). When emphasis is placed on suppressing an increase in resistance value and capacity deterioration under a high temperature condition, β more preferably contains at least Ti.

In Formulas (II) and (II′), 0.2≤a≤0.8 is preferable, 0.3≤a≤0.75 is more preferable, and 0.3≤a≤0.6 is more still preferable. In Composition Formulas (II) and (II′), 0.1≤b≤0.4 may be satisfied, and, 0.1≤b≤0.3, or 0.2≤b≤0.3 is more preferable. In Composition Formulas (II) and (II′), 0.1≤c≤0.4 may be satisfied, and, 0.1≤c≤0.3, or 0.2≤c≤0.3 is more preferable. In Composition Formula (II′), 0≤d≤0.08 may be satisfied, 0.005≤d≤0.07, or 0.01≤d≤0.05 may be satisfied.

### [Method for Producing Solid-State Battery]

The solid-state battery of the present disclosure can be manufactured by a printing method such as a screen printing method or the like, a green sheet method using a green sheet, or a method combining these methods. Hereinafter, a case where the printing method and the green sheet method are adopted for understanding the present disclosure will be described in detail, but the present disclosure is not limited to these methods. That is, the solid-state battery may be produced according to a common method for producing a solid-state battery. In addition, the following time-dependent matters such as the order of descriptions are merely considered for convenience of explanation, and the present disclosure is not necessarily bound by the matters.

### (Step of Forming Solid-State Battery Laminate Precursor)

In the present step, for example, several types of pastes such as a positive electrode layer paste, a negative electrode layer paste, a solid electrolyte layer paste, a positive electrode current collector layer paste, a negative electrode current collector layer paste, an electrode separator paste, and an outer layer material paste are used as ink. That is, a solid-state battery laminate precursor having a predetermined structure is formed on a supporting substrate by applying and drying the paste by the printing method.

In printing, a solid-state battery laminate precursor corresponding to a predetermined solid-state battery structure can be formed on a substrate by sequentially laminating printing layers with a predetermined thickness and pattern shape. The type of the pattern forming method is not particularly limited as long as it is a method capable of forming a predetermined pattern, and is, for example, any one or two or more of a screen printing method and a gravure printing method.

The paste can be prepared by wet mixing a predetermined constituent material of each layer appropriately selected from the group consisting of positive electrode active material particles, negative electrode active material particles, a conductive material, a solid electrolyte material, a current collector layer material, an insulating material, a sintering aid, and other materials described above with an organic vehicle in which an organic material is dissolved in a solvent.

The positive electrode layer paste contains, for example, the positive electrode active material particles, the solid electrolyte material, an organic material, a solvent, and optionally a sintering aid.

The negative electrode layer paste contains, for example, the negative electrode active material particles, the solid electrolyte material, an organic material, a solvent, and optionally a sintering aid.

The solid electrolyte layer paste contains, for example, the solid electrolyte material, an organic material, a solvent, and optionally a sintering aid.

The positive electrode current collector layer paste contains a conductive material, an organic material, a solvent, and optionally a sintering aid.

The negative electrode current collector layer paste contains a conductive material, an organic material, a solvent, and optionally a sintering aid.

The electrode separator paste contains, for example, the solid electrolyte material, an insulating material, an organic material, a solvent, and optionally a sintering aid.

The outer layer material paste contains, for example, an insulating material, an organic material, a solvent, and optionally a sintering aid.

The organic material contained in the paste is not particularly limited, but at least one polymer material selected from the group consisting of a polyvinyl acetal resin, a cellulose resin, a polyacrylic resin, a polyurethane resin, a polyvinyl acetate resin, a polyvinyl alcohol resin, and the like can be used.

The type of the solvent is not particularly limited, and the solvent is, for example, one or two or more organic solvents such as butyl acetate, N-methyl-pyrrolidone, toluene, terpineol, and N-methyl-pyrrolidone.

In the wet mixing, a medium can be used, and specifically, a ball mill method, a Visco mill method, or the like can be used. On the other hand, a wet mixing method that does not use a medium may be used, and a sand mill method, a high-pressure homogenizer method, a kneader dispersion method, or the like can be used.

The supporting substrate is not particularly limited as long as the supporting substrate is a support capable of supporting each paste layer, and the supporting substrate is, for example, a release film having one surface subjected to a release treatment, or the like. Specifically, a substrate formed from a polymer material such as polyethylene terephthalate can be used. When the paste layer is used in the firing step while being held on the substrate, the substrate having heat resistance to firing temperature may be used.

Alternatively, each green sheet may be formed from each paste, and the obtained green sheets may be stacked to prepare a solid-state battery laminate precursor.

Specifically, the supporting substrate applied with each paste is dried on a hot plate heated to 30° C. or higher and 90° C. or lower to form, on each supporting substrate (for example, a PET film), a positive electrode layer green sheet, a negative electrode layer green sheet, a solid electrolyte layer green sheet, a positive electrode current collector layer green sheet, a negative electrode current collector layer green sheet, an electrode separator green sheet and/or an outer layer material green sheet or the like having a predetermined shape and thickness.

Next, each green sheet is peeled off from the substrate. After the peeling, the green sheets of the constituent elements are sequentially stacked along the stacking direction to form a solid-state battery laminate precursor. After the stacking, a solid electrolyte layer, an insulating layer and/or a protective layer may be provided in a side region of an electrode green sheet by screen printing.

### (Firing Step)

In the firing step, the solid-state battery laminate precursor is subjected to firing. Although the followings are merely examples, firing is carried out by removing the organic material by heating in a nitrogen gas atmosphere containing oxygen gas or in the atmosphere, for example, at 200° C. or higher, and then heating in the nitrogen gas atmosphere or in the atmosphere, for example, at 300° C. or higher. Firing may be carried out while pressurizing the solid-state battery laminate precursor in the stacking direction (in some cases, stacking direction and direction perpendicular to the stacking direction).

By undergoing such firing, a solid-state battery laminate is formed, so that a desired solid-state battery is finally obtained.

### (Step of Forming Positive Electrode Terminal and Negative Electrode Terminal)

For example, the positive electrode terminal is bonded to the solid-state battery laminate using a conductive adhesive, and the negative electrode terminal is bonded to the solid-state battery laminate using a conductive adhesive. Consequently, each of the positive electrode terminal and the negative electrode terminal is attached to the solid-state battery laminate, so that the solid-state battery is completed.

### EXAMPLES

Verification tests were performed in accordance with the present disclosure. The structure of FIG. 2 was adopted for the structure of the solid-state battery.

### Example 1

### (Step of Producing Solid Electrolyte Layer Green Sheet)

First, lithium borosilicate glass as a solid electrolyte and an acrylic binder were mixed at a mass ratio of lithium borosilicate glass:acrylic binder=70:30. As the lithium borosilicate glass, one having a composition of Li₂O:SiO₂:B₂O₃=60:10:30 (mol % ratio) was used. Next, the resulting mixture was mixed with butyl acetate so that the solid content was 30 mass %, and then this mixture was stirred with zirconia balls having a diameter of 5 mm for 4 hours to obtain a solid electrolyte layer paste. Subsequently, the paste was applied onto a release film and dried at 80° C. for 10 minutes to produce a solid electrolyte layer green sheet as a solid electrolyte layer precursor.

### (Step of Producing Positive Electrode Material Layer Green Sheet)

First, titanium-containing lithium cobalt oxide (LiCoO₂) was synthesized by a solid phase method in which cobalt oxide, lithium carbonate, and titanium were mixed and fired. Titanium-containing lithium cobalt oxide having a 003 plane spacing was obtained by controlling the mixing conditions and the firing temperature.

Next, the titanium-containing lithium cobalt oxide (LiCoO₂) as a positive electrode active material and the lithium borosilicate glass as a solid electrolyte were mixed in a mass ratio of titanium-containing lithium cobalt oxide:lithium borosilicate glass=75:25. Next, the resulting mixture and an acrylic binder were mixed at a mass ratio of mixture (titanium-containing lithium cobalt oxide+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a positive electrode material layer paste. Subsequently, this paste was applied onto a release film and dried at 80° C. for 10 minutes to produce a positive electrode material layer green sheet as a positive electrode material layer precursor.

### (Step of Producing Negative Electrode Material Layer Green Sheet)

First, a carbon powder (KS 6 manufactured by TIMCAL Ltd.) as a negative electrode active material and lithium borosilicate glass as a solid electrolyte were mixed in a mass ratio of carbon powder:lithium borosilicate glass=70:30. Next, the resulting mixture and an acrylic binder were mixed at a mass ratio of mixture (carbon powder+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a negative electrode material layer paste. Subsequently, this paste was applied onto a release film and dried at 80° C. for 10 minutes to produce a negative electrode material layer green sheet as a negative electrode material layer precursor.

### (Step of Producing Positive Electrode Current Collector Layer Green Sheet)

First, a carbon powder (KS 6 manufactured by TIMCAL Ltd.) as a conductive material and lithium borosilicate glass as a solid electrolyte were mixed in a mass ratio of carbon powder:lithium borosilicate glass=70:30. Next, the resulting mixture and an acrylic binder were mixed at a mass ratio of mixture (carbon powder+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a positive electrode current collector layer paste. Subsequently, this paste was applied onto a release film and dried at 80° C. for 10 minutes to produce a positive electrode current collector layer green sheet as a positive electrode current collector layer precursor.

### (Step of Producing Negative Electrode Current Collector Layer Green Sheet)

A negative electrode current collector layer green sheet was produced in the same manner as in “Step of producing positive electrode current collector layer green sheet” described above.

### (Step of Producing Outer Layer Material Green Sheet)

First, an alumina particle powder (AHP 300 manufactured by Nippon Light Metal Company, Ltd.) as a particle powder and lithium borosilicate glass as a solid electrolyte were mixed in a mass ratio of alumina particle powder:lithium borosilicate glass=50:50. Next, the resulting mixture and an acrylic binder were mixed at a mass ratio of mixture (alumina particle powder+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a principal surface outer layer material paste. Subsequently, this paste was applied onto a release film and dried to produce an outer layer material green sheet as a principal surface outer layer material precursor.

### (Step of Producing Electrode Separator Green Sheet)

An electrode separator green sheet as an electrode separator precursor was produced in the same manner as in “Step of producing outer layer material green sheet” described above.

### (Step of Preparing Laminate)

Using each green sheet obtained as described above, a laminate having the configuration shown in FIGS. 1 and 2 was prepared as follows. First, each green sheet was processed into the shape shown in FIGS. 1 and 2, and then released from the release film. Subsequently, the green sheets were sequentially stacked so as to correspond to a configuration of a battery element shown in FIGS. 1 and 2, and then thermocompression-bonded. As a result, a laminate as a battery element precursor was obtained.

### (Step of Sintering Laminate)

The obtained laminate was heated to remove the acrylic binder contained in each green sheet, and then further heated to sinter the oxide glass contained in each green sheet.

### (Step of Producing Terminal)

First, an Ag powder (Daiken Chemical Co., Ltd.) as a conductive particle powder and oxide glass (Bi—B based glass, ASF1096 manufactured by Asahi Glass Co., Ltd.) were mixed at a predetermined mass ratio. Next, the resulting mixture and an acrylic binder were mixed in a mass ratio of mixture (Ag powder+oxide glass):acrylic binder=70:30, and then this mixture was mixed with a butyl acetate solvent so that the solid content was 50 mass %. Then, the resulting mixture was stirred with zirconia balls having a diameter of 5 mm for 4 hours to obtain a conductive paste. Next, after this conductive paste was applied onto the release film, the conductive paste was attached to first and second end surfaces (or side surfaces) of the laminate in which the positive electrode current collector layer and the negative electrode current collector layer were exposed, respectively, and sintered to form positive and negative electrode terminals. As a result, a target battery was obtained.

### Example 2

A solid-state battery was produced in the same manner as in Example 1, except that the composition ratio of the positive electrode active material was changed.

### Examples 3 to 5

A solid-state battery was produced in the same manner as in Example 1, except that a predetermined amount of Al was further added as a positive electrode active material.

### Examples 6 to 8

A solid-state battery was produced in the same manner as in Example 1, except that a predetermined amount of Mg was further added as a positive electrode active material.

### Example 9

A solid-state battery was produced in the same manner as in Example 1, except that a mixture of lithium borosilicate glass and a LiLaZr-based oxide (lithium borosilicate glass:LiLaZr-based oxide=60:40 (mass ratio)) was used as a solid electrolyte. As the LiLaZr-based oxide, Li—La₃Zr₂O₁₂ was used.

### Examples 10 and 11

A solid-state battery was produced in the same manner as in Example 1, except that a LiNiCoMn-based oxide was used as a positive electrode active material.

### Comparative Example 1

A solid-state battery was produced in the same manner as in Example 1, except that a titanium-free lithium cobalt oxide was used as a positive electrode active material.

### Comparative Example 2

A solid-state battery was produced in the same manner as in Example 1, except that a LiLaZr-based oxide was used as a solid electrolyte. As the LiLaZr-based oxide, Li₇La₃Zr₂O₁₂ was used.

### (Measurement of Battery Characteristics)

A rated capacity of the battery was set to 1 C, the battery was charged to a predetermined positive electrode potential at a constant current of 0.2 C, after reaching the positive electrode potential, the battery was charged in a constant voltage mode until the current was contracted to 0.01 C, and impedance measurement was performed to determine an initial resistance value. Thereafter, the battery was stored at a high temperature condition (105° C.) for 1 week, slowly cooled to 25° C. by air cooling, then subjected to impedance measurement at 25° C., discharged to 2 V at a constant current of 0.2 C, and subjected to capacity measurement. Note that, as the positive electrode potential, different potentials were used according to the positive electrode active material. Specifically, charging was performed up to a positive electrode potential of 4.35 V when the positive electrode active material is a LiCo-based oxide, or 4.2 V when the positive electrode active material is a LiNiCoMn-based oxide.

The resistance increase rate was calculated by dividing the resistance value after storage under a high temperature condition by the initial resistance value obtained from the result of impedance measurement. From the results of capacity measurement, the deterioration capacity of the discharge capacity after storage under a high temperature condition was determined.

### (X-Ray Diffraction Measurement)

The 003 plane spacing of the positive electrode active material was measured by an X-ray diffraction measuring apparatus (D8 Advance manufactured by Bruker Corporation). The battery was charged at a current value of 0.2 C, and after reaching a positive electrode potential of 4.55 V, constant current constant voltage charge in which charging was performed until the current was reduced to 0.01 C was performed, and the lithium desorption amount of the positive electrode active material was set to 40%, and then the positive electrode layer was taken out from the solid-state battery and filled in a sample folder of an X-ray diffraction measuring apparatus. In a measurement temperature range of 25° C. to 500° C., a target temperature was set at intervals of 20° C., and the positive electrode layer was heated at a temperature increase rate of 10° C./min. After reaching the target temperature, a waiting time of 3 minutes was passed, and then X-ray diffraction measurement was performed. The Step width in the X-ray diffraction measurement was 0.01°, the count time was 0.3 seconds or more, the scanning speed was 10°/min, and the angular range was 15° to 70°.

Specifically, the positive electrode layer is exposed by polishing or disassembling. After confirming by voltage measurement with a tester that no short circuit due to work has occurred, XRD measurement is performed as described above. When there is a concern about material alteration due to atmospheric exposure, a series of operations and measurements are performed under an inert atmosphere.

Among peaks caused by 003 in an XRD spectrum of the positive electrode active material obtained as described above, the spacing at the angle showing the maximum intensity is calculated, and defined as the spacing. The maximum value of the spacing (that is, maximum spacing) in a measurement temperature range was set to 1, and the temperature at which the relative spacing with respect to the maximum spacing was less than 0.995 at a temperature higher than the temperature at which the maximum spacing was obtained was defined as the self-decomposition temperature.

Table 1 shows evaluation results of the solid-state batteries of Examples 1 to 11 and Comparative Examples 1 and 2. Note that, as for the resistance increase rate and the deterioration capacity, the relative resistance increase rate and the relative deterioration capacity of Comparative Example 2 and Examples 1 to 11 are shown as relative values when the resistance increase rate and the deterioration capacity in Comparative Example 1 are each “100”.

TABLE 1

| | | | | All-solid-state battery | |
|---|---|---|---|---|---|
| | | | | performance | |
| | Composition of | | | Relative | Relative |
| | positive electrode | Solid | Self-decomposition | resistance | deterioration |
| | active material | electrolyte | temperature (° C.) | increase rate | capacity |
| Example 1 | LiCo_{0.995}Ti_{0.005}O₂ | Lithium | 281 | 33 | 85 |
| | | borosilicate | | | |
| | | glass | | | |
| Example 2 | LiCo_{0.99}Ti_{0.01}O₂ | Lithium | 284 | 31 | 86 |
| | | borosilicate | | | |
| | | glass | | | |
| Example 3 | LiCo_{0.985}Ti_{0.005}Al_{0.01}O₂ | Lithium | 285 | 21 | 73 |
| | | borosilicate | | | |
| | | glass | | | |
| Example 4 | LiCo_{0.965}Ti_{0.005}Al_{0.03}O₂ | Lithium | 286 | 12 | 60 |
| | | borosilicate | | | |
| | | glass | | | |
| Example 5 | LiCo_{0.945}Ti_{0.005}Al_{0.05}O₂ | Lithium | 290 | 13 | 59 |
| | | borosilicate | | | |
| | | glass | | | |
| Example 6 | LiCo_{0.985}Ti_{0.005}Mg_{0.01}O₂ | Lithium | 283 | 20 | 70 |
| | | borosilicate | | | |
| | | glass | | | |
| Example 7 | LiCo_{0.965}Ti_{0.005}Mg_{0.03}O₂ | Lithium | 285 | 10 | 76 |
| | | borosilicate | | | |
| | | glass | | | |
| Example 8 | LiCo_{0.945}Ti_{0.005}Mg_{0.05}O₂ | Lithium | 289 | 6 | 91 |
| | | borosilicate | | | |
| | | glass | | | |
| Example 9 | LiCo_{0.995}Ti_{0.005}O₂ | Lithium | 280 | 40 | 90 |
| | | borosilicate | | | |
| | | glass + | | | |
| | | LiLaZr-based | | | |
| | | oxide | | | |
| Example 10 | LiNi_{0.6}Co_{0.2}Mn_{0.2}O₂ | Lithium | 315 | 46 | 21 |
| | | borosilicate | | | |
| | | glass | | | |
| Example 11 | LiNi_{0.3}Co_{0.3}Mn_{0.3}O₂ | Lithium | 295 | 50 | 28 |
| | | borosilicate | | | |
| | | glass | | | |
| Comparative | LiCoO₂ | Lithium | 213 | 100 | 100 |
| Example 1 | | borosilicate | | | |
| | | glass | | | |
| Comparative | LiCo_{0.995}Ti_{0.005}O₂ | LiLaZr-based | 271 | 66 | 115 |
| Example 2 | | oxide | | | |

According to the above results, the solid-state battery of each of Examples 1 to 11 exhibited favorable battery characteristics even after storage under a high temperature condition, as compared with the solid-state battery of Comparative Example 1 using the conventional positive electrode active material having self-decomposition temperature of a positive electrode active material of lower than 215° C., and the solid-state battery of Comparative Example 2 using a LiLaZr-based oxide without containing lithium borosilicate glass as a solid electrolyte. Specifically, in the solid-state battery of each of Examples 1 to 11 in which the self-decomposition temperature of the positive electrode active material was 215° C. or higher and the solid electrolyte contained lithium borosilicate glass, even after storage under a high temperature condition, the results showing lower values in the resistance increase rate and the deterioration capacity than those of Comparative Examples 1 and 2 were obtained. That is, the solid-state battery of the present disclosure can suitably suppress deterioration of battery characteristics even under a high temperature condition. Therefore, according to the present disclosure, a solid-state battery having more suitable battery characteristics even under a high temperature condition is provided.

### (Measurement of Cycle Characteristics)

In addition, for the solid-state batteries of Examples 1 to 11 and Comparative Examples 1 and 2, the capacity retention rate was measured in order to evaluate the initial battery characteristics before exposure to a high temperature condition. Specifically, a rated capacity of the battery was set to 1 C, the battery was charged to the above-described positive electrode potential at a constant current of 0.2 C, and after reaching the positive electrode potential, the battery was charged in a constant voltage mode until the current was contracted to 0.01 C. Thereafter, discharge was performed at a constant current of 0.2 C until the positive electrode potential reaches 3 V. A capacity retention rate with respect to an initial discharge capacity when 100 cycles were repeated with such charge and discharge as 1 cycle was measured. The results are shown in Table 2.

TABLE 2

| | Composition of | | | Capacity |
|---|---|---|---|---|
| | positive electrode | | Self-decomposition | retention |
| | active material | Solid electrolyte | temperature (° C.) | rate (%) |
| Example 1 | LiCo_{0.995}Ti_{0.005}O₂ | Lithium borosilicate glass | 281 | 62 |
| Example 2 | LiCo_{0.99}Ti_{0.01}O₂ | Lithium borosilicate glass | 284 | 64 |
| Example 3 | LiCo_{0.985}Ti_{0.005}Al_{0.01}O₂ | Lithium borosilicate glass | 285 | 65 |
| Example 4 | LiCo_{0.965}Ti_{0.005}Al_{0.03}O₂ | Lithium borosilicate glass | 286 | 67 |
| Example 5 | LiCo_{0.945}Ti_{0.005}Al_{0.05}O₂ | Lithium borosilicate glass | 290 | 67 |
| Example 6 | LiCo_{0.985}Ti_{0.005}Mg_{0.01}O₂ | Lithium borosilicate glass | 283 | 62 |
| Example 7 | LiCo_{0.965}Ti_{0.005}Mg_{0.03}O₂ | Lithium borosilicate glass | 285 | 61 |
| Example 8 | LiCo_{0.945}Ti_{0.005}Mg_{0.05}O₂ | Lithium borosilicate glass | 289 | 69 |
| Example 9 | LiCo_{0.995}Ti_{0.005}O₂ | Lithium borosilicate glass + | 280 | 71 |
| | | LiLaZr-based oxide | | |
| Example 10 | LiNi_{0.6}Co_{0.2}Mn_{0.2}O₂ | Lithium borosilicate glass | 315 | 48 |
| Example 11 | LiNi_{0.3}Co_{0.3}Mn_{0.3}O₂ | Lithium borosilicate glass | 295 | 46 |
| Comparative | LiCoO₂ | Lithium borosilicate glass | 213 | 50 |
| Example 1 | | | | |
| Comparative | LiCo_{0.995}Ti_{0.005}O₂ | LiLaZr-based oxide | 271 | 75 |
| Example 2 | | | | |

According to the above results, the solid-state battery of each of Examples 10 and 11 containing lithium borosilicate glass as a solid electrolyte and including a positive electrode active material having a self-decomposition temperature of 295° C. or higher had a lower capacity retention rate than that of Comparative Example 1. That is, the positive electrode active material having a self-decomposition temperature of 295° C. or higher can suitably maintain the battery characteristics even under a high temperature condition, but exhibits a relatively low value for the capacity retention rate. On the other hand, the solid-state battery of each of Examples 1 to 9 in which the self-decomposition temperature of the positive electrode active material was 215° C. or higher and lower than 295° C. can maintain suitable battery characteristics even after storage under a high temperature condition, and exhibited a suitable value for the capacity retention rate before exposure to a high temperature condition.

Although the embodiments of the present disclosure have been described above, typical examples have been only illustrated. Therefore, those skilled in the art will easily understand that the present disclosure is not limited thereto, and various embodiments are conceivable without changing the scope of the present disclosure.

The solid-state battery of the present disclosure can be used in various fields in which electricity storage is assumed. Although the followings are merely examples, the solid-state battery of the present disclosure can be used in electricity, information and communication fields where mobile equipment and the like are used (e.g., electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (e.g., the fields such as spacecraft and research submarines).

### DESCRIPTION OF REFERENCE SYMBOLS

10: Electrode layer
10A: Positive electrode layer
10B: Negative electrode layer
11: Electrode current collector layer
11A: Positive electrode current collector layer
11B: Negative electrode current collector layer
20: Solid electrolyte layer
30: Electrode separator
30A: Positive electrode separator
30B: Negative electrode separator
40: Terminal
40A: Positive electrode terminal
40B: Negative electrode terminal
60: Outer layer material
100: Solid-state battery laminate
200: Solid-state battery

1. A solid-state battery comprising:
a positive electrode layer containing a positive electrode active material containing lithium and a solid electrolyte, wherein
the positive electrode layer has a self-decomposition temperature of 215° C. or higher, and the solid electrolyte contains lithium borosilicate glass.

2. The solid-state battery according to claim 1, wherein the positive electrode active material has a layered rock salt-type crystal structure.

3. The solid-state battery according to claim 1, wherein the self-decomposition temperature is 215° C. or higher and 400° C. or lower.

4. The solid-state battery according to claim 1, wherein the self-decomposition temperature is 215° C. or higher and 315° C. or lower.

5. The solid-state battery according to claim 1, wherein a content of the lithium borosilicate glass in the solid electrolyte is 10 mass % to 90 mass % with respect to the total amount of the solid electrolyte in the positive electrode layer.

6. The solid-state battery according to claim 1, wherein the positive electrode active material contains an oxide containing Li, Co, and Ti.

7. The solid-state battery according to claim 6, wherein the self-decomposition temperature is 215° C. or more and lower than 295° C.

8. The solid-state battery according to claim 6, wherein the positive electrode active material further contains Mg and/or Al.

9. The solid-state battery according to claim 6, wherein the oxide is represented by LiCoₓTi_{y}α_{z}O₂, wherein x+y+z≤1, 0.9≤x<1, 0.005≤y≤0.01, 0≤z≤0.05, and α is Mg and/or Al.

10. The solid-state battery according to claim 1, wherein the positive electrode active material contains an oxide containing Li, Ni, Co, and Mn.

11. The solid-state battery according to claim 10, wherein the oxide is represented by LiNiₐCo_{b}Mn_{c}O₂, wherein a+b+c≤1, 0.3≤a≤0.6, 0.2≤b≤0.3, 0.2≤c≤0.3.

12. The solid-state battery according to claim 10, wherein the oxide is represented by LiNiₐCo_{b}Mn_{c}β_{d}O₂, wherein a+b+c≤1, 0.3≤a≤0.6, 0.1≤b≤0.3, 0.1≤c≤0.3, 0≤d≤0.05, and β is at least one element selected from Ti, Mg, and Al.

13. The solid-state battery according to claim 1, wherein the solid electrolyte further contains an oxide-based solid electrolyte having a garnet-type crystal structure.

14. The solid-state battery according to claim 13, wherein the oxide-based solid electrolyte is an oxide containing Li, La, and Zr.
